(19) United States
(12) Patent Application Publication
(10) Pub. No.: US 2010/0198688 A1
(43) Pub. Date: Aug. 5, 2010

(54) METHOD, SYSTEM, OR APPARATUS FOR A TRUTHFUL PRICING SCHEME FOR A SELLER

(75) Inventors: Rica Gonen, Sunnyvale, CA (US); Sergei Vassilvitskii, New York, NY (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/365,082

(22) Filed: Feb. 3, 2009

(51) Int. Cl. G06Q 30/00; G06Q 10/00

(52) U.S. Cl. 705/14.54; 705/400; 705/26; 705/34

(57) ABSTRACT

Embodiments of methods, apparatuses, or systems relating to truthful pricing schemes for a seller.

### BACKGROUND

1. Field

The subject matter disclosed herein relates to a truthful pricing scheme for a seller.

2. Information

Advertisements may be found in newspapers, magazines, radio, television, and, in our most modern medium of expression the “online” world. Advertisements present opportunity for those that own or operate advertising space to generate revenue. And, for those that wish to advertise, purchasing advertising space may generate additional exposure to a particular item or service.

While a marriage between those that wish to advertise and those that own or operate advertising space would appear harmonious, the reality may be quite the opposite. Some markets for advertising space, for example, may produce or result in undesirable economic conditions for one or more market participants. Thus, other technologies and/or approaches may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting an embodiment of an exemplary method for a truthful pricing scheme for a seller.

FIG. 2 is a schematic diagram depicting an embodiment of an exemplary apparatus to implement or support a truthful pricing scheme for a seller.

FIG. 3 is a schematic diagram depicting an embodiment of an exemplary system to implement or support a truthful pricing scheme for a seller.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment”, “an embodiment”, or “certain embodiments” may mean that a particular feature, structure, or characteristic described in connection with one or more particular embodiments may be included in at least one embodiment of claimed subject matter. Thus, appearances of the phrase “in one embodiment”, “an embodiment”, “certain embodiments”, or the like in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and”, “and/or”, and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals, information, and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's memories, registers, and/or other information storage, transmission, and/or display devices.

As mentioned previously, existing mechanisms and/or approaches utilized for markets for advertising space may produce, or result in, undesirable economic conditions for one or more market participants. For example, in some markets for advertising space, the efficacy of a particular mechanism or approach may place greater emphasis on one or more market participants to truthfully report his or her bids and/or costs. To illustrate, a seller of an advertising slot (e.g., advertising space) may overstate or inflate its costs, such as by submitting a reserve price to an advertising market which may overstate the seller's costs for a particular advertising slot. The effects of untruthful behavior by one or more market participants may vary by market; accordingly, a brief discussion of a just a few advertising markets is presented.

One market for advertising may be termed a “sponsored search” market. Sponsored search markets represent one way that search providers monetize their search engines. Sponsored search markets allow advertisers and/or associated agents to bid on particular queries that may target certain users, typically in an auction environment. In general, sponsored search auctions tend to have a simple framework. In a typical sponsored search auction, an advertiser (e.g., buyer) specifies a query to advertise on, and submits a bid for that query, representing the maximum amount that advertiser is willing to pay. When a user enters a query, a sponsored search auction system collects the advertisers' bids for that query, and runs a generalized second price auction to determine which advertisers win and what prices each winner may be charged. Accordingly, there are usually multiple winners, as there are multiple slots for advertising on a search result page. Typically, higher slots tend to be more valuable since they may be seen by more users and/or may be more conspicuously displayed to a user viewing a search results page. Finally, a winning advertiser may be charged in the event of a user clicking on their advertisement; otherwise typically no payment is made. Charging in the event of user click has been termed a so-called “pay-per-click” scheme. In a sponsored search auction, where advertisements are typically presented alongside search results, it is generally a search engine that controls the placement of an advertisement and any reserve prices for advertisement slots.

Recently, a market for sponsored search may be evolving into networks of advertisers and publishers. Thus, another advertising market may be formed, which may be termed a syndicated sponsored search market. For example, networks between advertisers (e.g., buyers) and publishers (e.g., sellers) appear to be forming and, with such networks, publishers may offer to place advertisements along certain content pages. Thus, in a syndicated environment, publishers may act as a seller of advertising slots. In contrast, in a typical sponsored search environment, a search engine generally acts as a seller of an advertising slot. Accordingly, in a syndicated environment, a search engine may tend to occupy a different position than it did in a more traditional environment, e.g., that of a market maker.

Certain syndicated sponsored search markets may present particular concerns in contrast to more traditional sponsored search markets. One concern in a syndicated environment, for example, may be that publishers, rather than search engines, may set reserve prices for advertisement slots. Publishers, for example, may attempt to set reserve prices for advertisement based, at least in part, on costs or other like factors, such as a potential decrease in user satisfaction relating to the placement of advertisements with, or along with, certain content. Thus, in certain syndicated sponsored search markets, there may be some concern relating to publishers truthfully reporting such costs, or other like factors, which may relate to reserve prices for their advertisement slots.

Other markets for adverting may include more traditional markets, such as newspaper, television, or radio advertising markets, which may also experience undesirable economic conditions due to potentially less truthful behavior. These more traditional advertising markets, and more recent advertising markets, such as banner advertisement markets, for example, may each somewhat rely on truthful behavior by one or more market participants to produce and/or sustain a stable market for advertisement slots.

With this and other concerns in mind, in accordance with certain aspects of the present description, example implementations may include methods, systems, or apparatuses for implementing or supporting a truthful pricing scheme for a seller and/or an associated agent. In an implementation, for example, a pricing scheme may be determined such that it may motivate one or more sellers to truthfully report costs (e.g., costs or other like factors) to a buyer, or to a third-party, such as a buyer's agent or a market maker. For example, in an implementation, a seller may submit a reserve price for a particular advertising slot where the reserve price truthfully reports that sellers' cost for that particular advertising slot.

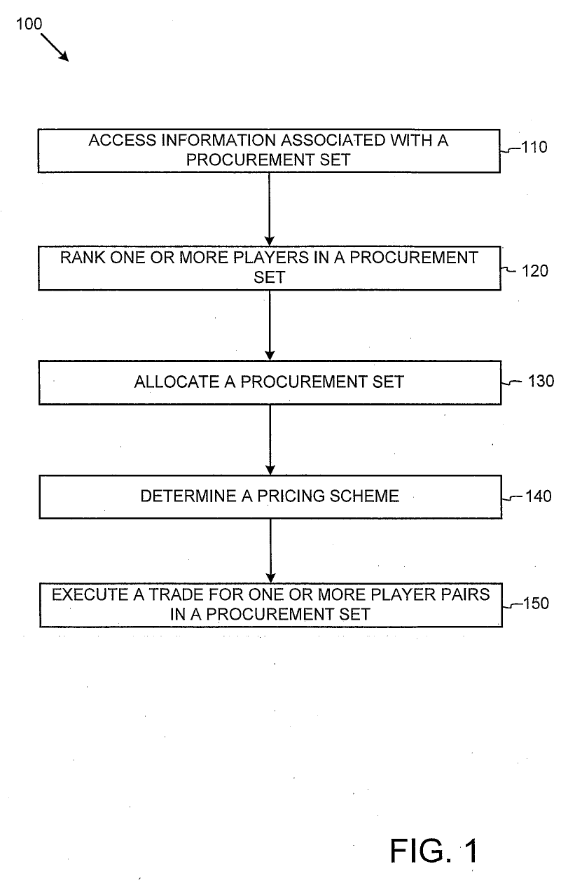

Attention is now drawn to FIG. 1, which is a flow chart depicting an exemplary embodiment of a method 100 for a truthful pricing scheme for a seller. At block 110 one or more processes may access information associated with a procurement set. In this context, a “procurement set” may be the minimum number of players for a trade to occur. For example, in an auction for advertisement slots, such as a double-sided auction, a procurement set may include a pair of players, such as at least one buyer and at least one seller, for example. Players, such as buyers or sellers, or their respective agents, may be associated with a plurality of advertising slots. Thus, in an example implementation, a buyer may have bids for multiple advertising slots in an auction. Correspondingly, a seller may have reserve prices for multiple advertising slots in an auction.

Accordingly, information associated with a procurement set may include information relating to one or more buyers or sellers, such as bid information, reserve price information, cost information, advertisement parameters, and so on, as non-limiting examples. In certain example implementations, accessing information associated with a procurement set may include accessing a buyer's bid or a seller's reserve price, or other information, which may be desirable for a market or auction for advertising slots.

In certain implementations, the term “advertisement parameter” may include a value which comprises a buyer advertisement parameter and/or a seller slot parameter. In an embodiment, a buyer advertisement parameter may be a value associated with a probability that a particular buyer's advertisement may be accessed and/or viewed. For example, in a sponsored search advertising environment, a buyer advertisement parameter may be a value associated with a probability that a user may access a particular buyer's advertisement, such as by clicking on it on a displayed search results page. As another example, in another advertising environment, such as newspaper advertising, a buyer advertisement parameter may be a value associated with a probability that a particular buyer's advertisement may be viewed.

Similarly, a seller slot parameter may be a value associated with a probability that a particular advertisement slot of a seller may be accessed and/or viewed. For example, in a sponsored search advertising environment, a seller advertisement parameter may be a value associated with a probability that a user may access a particular advertisement slot of a seller, such as by clicking on it on a displayed search results page. As another example, in another advertising environment, such as television advertising, a seller slot parameter may be a value associated with a probability that a particular buyer's advertisement may be viewed.

In certain example implementations, one or more players, one or more player agents, or one or more third-parties, such as a market maker, for example, may determine one or more advertisement parameters. Thus, in an example implementation, a seller may determine one or more seller slot parameters for one or more advertisement slots. For example, a seller may report a reserve price to a market maker for an advertisement slot where a reserve price may reflect a seller slot parameter for that slot. Accordingly, in an example implementation, a seller may determine a seller slot parameter for an advertising slot prior to reporting a reserve price for an advertising slot. In an example implementation, a seller may also determine costs for one or more advertisement slots, which may be reflected in a reserve price for one or more advertising slots.

While a variety of techniques or approaches may be used to determine a costs or a seller slot parameter, claimed subject matter is not to be limited to a particular technique or approach. For example, a seller may determine costs for a particular slot by determining values associated with a potential decrease in user satisfaction relating to the placement of advertisements with, or along with, certain content. A seller may determine a seller slot parameter, using various criteria which may include, but not be limited to, determining values associated with a position/location of an advertisement slot, such as an advertisement slot on a displayable web page, size or shape of an advertisement slot, frequency which it may be displayed in a particular medium, etc. In an implementation, a seller may truthfully submit reserve prices which may reflect costs or seller slot parameters for advertisement slots, to a third-party, such as a market maker.

In certain exemplary implementations, a third-party, such as a market maker may determine one or more advertisement parameters. For example, a third-party may access information associated with one or more buyers, one or more sellers, or other information that may be desirable for determining advertisement parameters, such as at block 110. A third-party, such as a market maker, may determine one or more advertisement parameters for one or more buyers or sellers.

At block 120, one or more processes may rank (e.g., operatively arrange) one or more players in a procurement set based, at least in part, on information accessed at block 110. In certain implementations, information used for ranking at block 120 may include buyer bids for advertisements slots and seller reserve prices for advertisement slots. While various ranking schemes may be utilized, in certain implementations, buyer bids may be ranked in substantially non-ascending (e.g., possibly descending) rank. For example, buyer bids may be ranked such that buyer i₁≧i₂≧i_{n . . .} and so forth, where i₁ may be a highest respective buyer's bid. In contrast, in certain implementations, seller players may be ranked in substantially non-descending (e.g., possibly ascending) rank. Thus, for example, sellers may be ranked such that seller j₁≦j₂≦j₃ and so forth, where j₁ may be a lowest respective reserve price of a seller. Accordingly, in an implementation, a buyer with a highest respective bid, i₁ may be ranked such that it may be paired with a seller with a lowest respective reserve price j_{1.} In addition, in certain implementations, one or more players may be ranked in a procurement set so that a next highest respective buyer's bid, such as i₂, may be ranked so that it may be paired with a next lowest respective seller's cost, such as j₂, and so on for a procurement set.

At block 130, one or more processes may allocate (e.g., operatively associate) a procurement set. For example, a procurement set may include determining which player pairings, such as buyer/seller pairing ranked at block 120, may have a positive gain from trade. For example, in certain implementations, player pairing that may have a positive gain from trade may be player pairs where a buyer's bid exceeds or may be equal to a seller's cost. For example, in an implementation, an allocation of a procurement set may determine that an allocation may include those pairings such that a buyer's bid, represented by bₘ, may be greater than or equal to a seller's cost, represented by cⱼ. Thus, for example, a procurement set may include buyer bids and seller costs for advertisement slots such that bₘ≧cⱼ. Alternatively and/or additionally, at block 130, one or more process may determine which player pairings may have a loss from trade, such as player pairs where bₘ<cⱼ. In an example implementation, player pairs which may have a loss from trade may be removed from a procurement set at block 130.

In certain example implementations, an allocation of a procurement set, such as may be allocated at block 130, may be an efficient allocation. For example, an efficient allocation may be an allocation of a procurement set where all player pairs in a procurement set may be capable of having a positive gain from trade.

At block 140, one or more processes may determine a pricing scheme. In certain example implementations, a pricing scheme may determine a price to be paid to a seller for a particular advertising slot. In an example implementation, a price paid to a seller for a particular advertising slot may be a function of a buyer's bid matched to a particular advertising slot and an advertisement parameter.

In an example implementation, a price paid to a seller for a particular advertising slot, slot j, may be a product of a buyer's bid matched to slot j, represented by bₘ₍ⱼ₎, and an advertisement parameter, represented by λ_{m(j),j}, such that a price paid to a seller may be bₘ₍ⱼ₎λ_{m(j),j}. Here, for example, an advertisement parameter, represented by λ_{m(j),j}, may include a buyer advertisement parameter and a sellers slot parameter λ_{m(j),j}. In an exemplary implementation for a sponsored search market, λ_{m(j),j}, may include a value associated with a click-through rate of a buyer matched to slot j, in slot j. In other words, λ_{m(j),j}, in an implementation, may be based, at least in part, on a probability that a particular buyer's advertisement will be accessed and/or a probability that an advertisement will be accessed for a particular slot. For example, λ_{m(j),j}, may be a product of a probability that a particular buyer's advertisement will be accessed and a probability that an advertisement will be accessed for a particular slot.

In certain example implementations, click-through rates may be based, at least in part, on a function of values associated with an advertiser's advertisement quality and/or a position in which an advertisement may appear upon display, as an example. For example, certain click-through rates may be the product of a function of values associated with an advertiser's advertisement quality and a position in which an advertisement may appear upon display.

In certain implementations, for example, at block 140 a pricing scheme may determine a total price to be paid to a seller for all a seller's advertising slot in a procurement set. Here, for example, a total price to be paid to a seller may be such that

$${p}_{seller} = {\sum }_{j ∈ A} \frac{{b}_{m ( j )} {λ}_{m ( j ) , j}}{{λ}_{j , j}} ,$$

where λ_{j,j} is a click-thorough rate of a buyer j in slot j. Of course, the above examples are merely illustrative and claimed subject matter is not intended to be limited to any particular example or illustration.

At block 150, one or more processes may execute a trade associated with one or more player pairs in a procurement set. In an example implementation, at block 150 one or more buyers may be charged prices, or a seller may receive a price determined at block 140. For example, in an implementation relating to sponsored search, a buyer may be charged that buyer's bid for a particular advertising slot and a seller may be paid for all its advertising slots such that

$${p}_{seller} = {\sum }_{j ∈ A} \frac{{b}_{m ( j )} {λ}_{m ( j ) , j}}{{λ}_{j , j}}$$

on a pay-per-click basis.

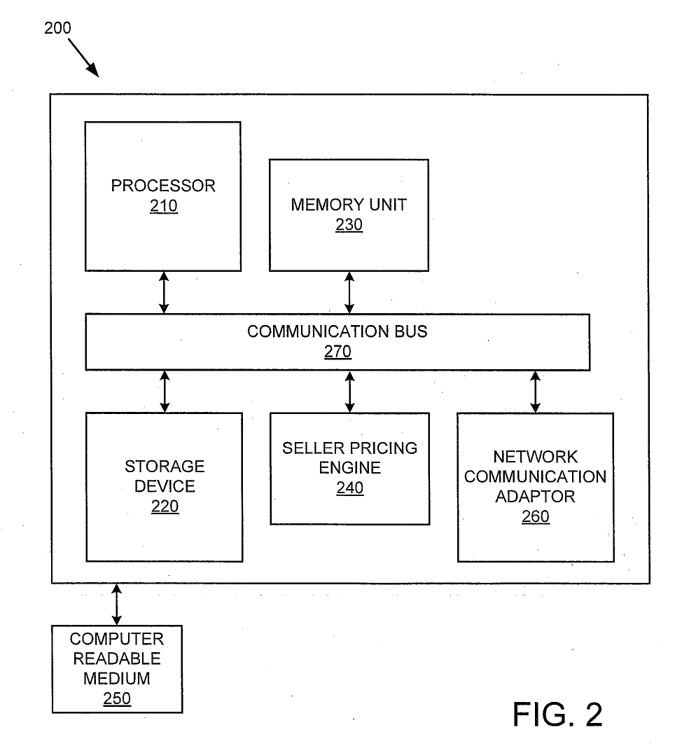

FIG. 2 is a schematic diagram depicting embodiment of an exemplary apparatus 200 implement or support a truthful pricing scheme for a seller. Here, apparatus 200 may include a special purpose computing platform, and/or the like. In this context, the phrase “special purpose computing platform” means or refers to a computing platform once it is programmed to perform particular functions pursuant to instructions from program software. Here, apparatus 200 depicts a special purpose computing platform that may include one or more processors, such as processor 210. Furthermore, apparatus 200 may include one or more memory devices, such as storage device 220, memory unit 230, seller pricing engine 240 or computer readable medium 250. In addition, apparatus 200 may include one or more network communication adapters, such as network communication adaptor 260. Apparatus 200 may also include a communication bus, such as communication bus 270, operable to allow one or more connected components to communicate under appropriate circumstances.

In an example embodiment, communication adapter 260 may be operable to receive information associated with one or more players in a procurement set, such as one or more buyer bids and/or seller slot costs. In addition, as non-limiting examples, communication adapter 260 may be operable to send or receive one or more signals corresponding to information associated with one or more players in a procurement set, or it may be operable to send or receive one or more signals corresponding to information relating to an execution of one or more trades, to one or more computing platforms (not depicted).

In an example embodiment, seller pricing engine 240 may be operable to perform one or more processes previously described, such as one or more process depicted in FIG. 1. For example, seller pricing engine 240 may by operable to access information associated with a procurement set, rank and match players, perform allocations, determine a pricing scheme, or execute a trade as non-limiting examples.

In certain embodiments, apparatus 200 may be operable to transmit or receive information relating to, or used by, one or more process or operations via communication adapter 260, computer readable medium 250, and/or have stored some or all of such information on storage device 220, for example. As an example, computer readable medium 250 may include some form of volatile and/or nonvolatile, removable/non-removable memory, such as an optical or magnetic disk drive, a digital versatile disk, magnetic tape, flash memory, or the like. In certain embodiments, computer readable medium 250 may have stored there on computer-readable instructions, executable code, and/or other data which may enable a computing platform to perform one or more processes or operations mentioned previously.

In certain example embodiments, apparatus 200 may be operable to store information relating to, or used by, one or more operations mentioned previously, such as information relating to one or more procurement sets, in memory unit 230 and/or storage device 220. It should, however, be noted that these are merely illustrative examples and that claimed subject matter is not limited in this regard. For example, information stored or processed, or operations performed, in apparatus 200 may be performed by other components or devices depicted or not depicted in FIG. 2. Operations performed by seller pricing engine 240 may be performed by processor 210 in certain embodiments. Operations performed by components or devices in apparatus 200 may be performed in distributed computing environments where one or more operations may be performed by remote processing devices which may be linked via a communication network.

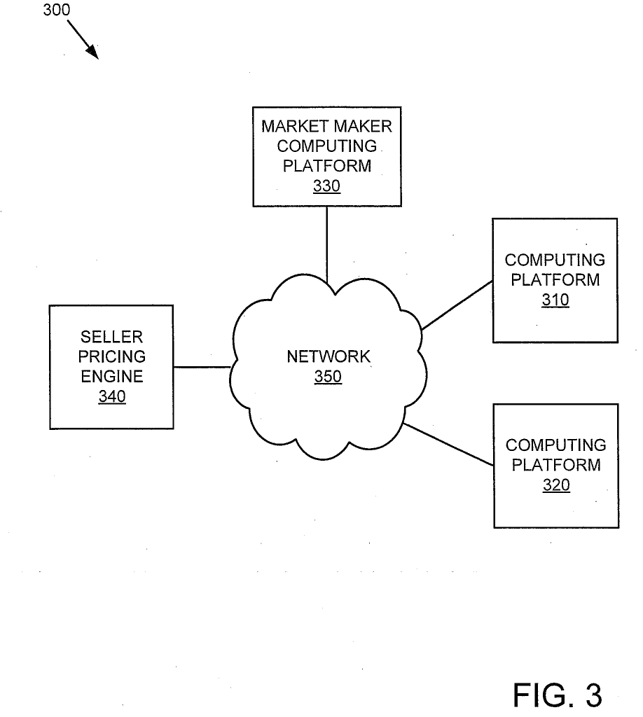

FIG. 3 is a schematic diagram depicting an embodiment of an exemplary system 300 that may be enabled implement or support a truthful pricing scheme for a seller. In system 300, a computing platform 310 may be communicatively coupled to a network 350. Here, in this example, computing platform 310 may be a computing platform associated with one or more buyers. Thus, for example, a buyer may submit a bid, as a non-limiting example, that may be transmitted via computing platform 310 and network 350. A computing platform 320 may also be communicatively coupled to network 350. Here, for example, computing platform 320 may be associated with one or more sellers. Thus, for example, a seller may submit a reserve price, as a non-limiting example, that may be transmitted via computing platform 320 and network 350.

System 300 may also include a market maker computing platform 330. Market maker computing platform 330, which may be associated with a search engine, for example, may be communicatively coupled to network 350. Market maker computing platform 330, in this example, may receive one or more bids or reserve prices from computing platform 310 or computing platform 320, respectively, via network 350. In certain embodiments, market maker computing platform 330 may access or have stored thereon information relating to one or more players in a procurement set, or other information, such as bid information, reserve price information, cost information, advertisement parameters, or other information associated with a market and/or auction for advertising slots, as non-limiting examples. Market maker computing platform 330 may transmit information to, or receive information from, one or more computing platforms communicatively coupled to network 350, such as seller pricing engine 340, for example.

In certain embodiments, market maker computing platform 330 may transmit information via network 350 to seller pricing engine 340 which may perform one or more process or operations to implement or support a truthful pricing scheme for sellers. For example, seller pricing engine 340 may receive or transmit information enabling it to perform one or more operations, such as determine rank and match players, perform allocations, determine a pricing scheme, or execute a trade, as non-limiting examples. Accordingly, in this example, seller pricing engine 340 may be capable of storing or transmitting results and/or information associated with one or more operations via network 350, such as transmitting a pricing scheme to market maker computing platform 330.

In certain embodiments, market maker computing platform 330 may receive or transmit information enabling it to perform one or more operations, such as determine rank and match players, perform allocations, determine a pricing scheme, or execute a trade, as non-limiting examples. Accordingly, in this example, market maker computing platform may be capable of storing or transmitting results and/or information associated with one or more operations via network 350.

Certain implementations and/or embodiments may have a variety of advantages. An advantage of an embodiment may be that a pricing scheme that motivates a seller to be truthful may be implemented. For example, in an embodiment, a pricing scheme may motivate a seller to truthfully report costs for one or more advertisement slots in a procurement set, such as by a seller submitting a reserve price for an advertisement slot that may truthfully report its costs for that advertisement slot. Similarly, in an embodiment, for every slot that is allocated, a seller may be paid the truthful price from an efficient allocation. Accordingly, a seller may have no (or less) incentive to deviate from a truthful strategy.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
accessing binary digital signals stored within a computing system memory, said binary digital signals representing information associated with a procurement set; and
determining a price to be paid to a seller in said procurement set for a particular advertising slot, said price being based, at least in part, on a buyer's bid matched to said particular advertising slot in said procurement set and an advertisement parameter.

2. The method of claim 1, wherein said information associated with a procurement set comprises one or more buyer's bids.

3. The method of claim 1, wherein said information associated with a procurement set comprises one or more seller's costs.

4. The method of claim 1, wherein said information associated with a procurement set comprises at least said advertisement parameter; and
wherein said advertisement parameter comprises at least one of a buyer advertisement parameter or a seller slot parameter.

5. The method of claim 1, further comprising ranking a plurality buyer's bids in said procurement set in non-ascending rank.

6. The method of claim 5, further comprising ranking a plurality of seller's costs in said procurement set in non-descending rank.

7. The method of claim 1, further comprising:
allocating said procurement set.

8. The method of claim 7, wherein said allocating said procurement set comprises matching a buyer's bid with a seller's cost.

9. The method of claim 7, wherein allocating said procurement set comprises establishing an efficient allocation.

10. The method of claim 1, further comprising:
determining a total price to be paid to a particular seller in said procurement set for all of said seller's advertising slots, which if paid to said seller, is such that
$${p}_{seller} = {\sum }_{j ∈ A} \frac{{b}_{m ( j )} {λ}_{m ( j ) , j}}{{λ}_{j , j}} .$$

11. The method of claim 1, wherein said procurement set comprises a procurement set of players in a sponsored search market.

12. The method of claim 1, wherein said sponsored search market comprises a syndicated sponsored search market.

13. An apparatus, comprising:
a seller pricing engine; wherein said seller pricing engine is operatively enabled to determine a price to be paid to a seller in a procurement set for a particular advertising slot, wherein said price, if paid to said seller, is a function of a buyer's bid matched to said particular advertising slot and an advertisement parameter.

14. The apparatus of claim 13, wherein said seller pricing engine is further operatively enabled to determine said advertisement parameter; wherein said advertisement parameter comprises a function of at least one of a buyer advertisement parameter or a seller slot parameter.

15. The apparatus of claim 13, wherein said seller pricing engine is communicatively coupled to a network of computing platforms.

16. The apparatus of claim 13, wherein said seller pricing engine is operatively coupled to a sponsored search market engine.

17. The apparatus of claim 13, wherein said seller pricing engine is operatively coupled to one or more storage devices; wherein said one or more storage devices are capable of storing one or more procurement sets.

18. An article, comprising:
a storage medium having instructions stored thereon; said storage medium, if said instructions are executed, further instructing a computing platform access information associated with a procurement set; and
further instructing said computing platform to determine a price to be paid to a seller in said procurement set for a particular advertising slot, said price being based, at least in part, on a buyer's bid matched to said particular advertising slot in said procurement set and an advertisement parameter.

19. The article of claim 18, wherein said advertisement parameter comprises a click-through rate.

20. The article of claim 18, further comprising:
further instructing said computing platform to determine a total price to be paid to a particular seller in said procurement set for all of said seller's advertising slots, which if paid to said seller, is such that
$${p}_{seller} = {\sum }_{j ∈ A} \frac{{b}_{m ( j )} {λ}_{m ( j ) , j}}{{λ}_{j , j}}$$
